(19) United States
(12) Patent Application Publication
(10) Pub. No.: US 2025/0045422 A1
(43) Pub. Date: Feb. 6, 2025

(54) POST-QUANTUM RISK ANALYSIS USING CIPHER SUITE DEPENDENCY GRAPHS AND RISK SCORING USING CALL PATHS

(71) Applicant: Cisco Technology, Inc., San Jose, CA (US)

(72) Inventors: Ashish Kundu, San Jose, CA (US); Ramana Rao V R Kompella, Foster City, CA (US)

(21) Appl. No.: 18/365,358

(22) Filed: Aug. 4, 2023

(51) Int. Cl. G06F 21/60; G06F 11/07

(52) U.S. Cl. CPC G06F 21/602; G06F 11/0793

(57) ABSTRACT

A method to identify and remediate unsafe cipher suite deployments. The method includes identifying a target to be analyzed, determining a collection of cipher suites used by the target, generating and displaying a cipher suite dependency graph for the target based on the collection of cipher suites, and classifying the target as being one of post-quantum computing safe and post-quantum computing unsafe based on the cipher suite dependency graph and based on a predetermined rule for each cipher suite in the collection of cipher suites. A cipher suite hosted by a target can be remediated to convert the target to a post-quantum computing safe state.

### TECHNICAL FIELD

The present disclosure relates to network and data security, and more particularly to techniques to identify and remediate a cipher suite deployment for a given target that may not be post-quantum computing safe.

### BACKGROUND

It has become increasingly clear that quantum computers may be used to break classical cryptography, or at least weaken security for systems, data, etc., that are protected by classical cryptography. Such classical cryptography may include, e.g., public key cryptography (PKI), such as Rivest-Shamir-Adleman (RSA), Elliptic-curve cryptography (ECC), and Advanced Encryption Standard (AES) techniques. Each such technique may be susceptible to the speed and versatility of quantum computing.

### BRIEF DESCRIPTION OF THE DRAWINGS

FIG. 1 shows several nodes, interconnected by an electronic network, including one server node that hosts risk analysis logic, according to an example embodiment.

FIG. 2 shows an example input user interface to initiate a scan of a target using risk analysis logic, according to an example embodiment.

FIG. 3 shows an example user interface depicting a cipher suite dependency graph and a graphical indication of risk determination for the target generated by risk analysis logic, according to an example embodiment.

FIG. 4A shows an example user interface depicting a cipher suite dependency graph and FIG. 4B shows a corresponding listing of cipher suite details generated for a target by risk analysis logic, according to an example embodiment.

FIG. 5A shows an example user interface for updating a database that stores information about individual cipher suites that is employed by risk analysis logic to perform risk analysis, according to an example embodiment, and FIG. 5B illustrates a single entry of such a database, according to an example embodiment.

FIG. 6 is a flowchart illustrating a series of operations executed by risk analysis logic, according to an example embodiment.

FIG. 7 is a block diagram of a computing device that may be configured to execute risk analysis logic and perform the techniques described herein, according to an example embodiment.

### DETAILED DESCRIPTION

### Overview

A computer-implemented method is provided to identify and remediate unsafe cipher suite deployments. The method includes identifying a target to be analyzed, determining a collection of cipher suites used by the target, generating and displaying a cipher suite dependency graph for the target based on the collection of cipher suites, and classifying the target as being one of post-quantum computing safe and post-quantum computing unsafe based on the cipher suite dependency graph and based on a predetermined rule for each cipher suite in the collection of cipher suites. A cipher suite hosted by a target can be remediated to convert the target to a post-quantum computing safe state.

In another embodiment, a device is provided. The device includes an interface configured to enable network communications, a memory, and one or more processors coupled to the interface and the memory, and configured to identify a target to be analyzed, determine a collection of cipher suites used by the target, generate and display a cipher suite dependency graph for the target based on the collection of cipher suites, and classify the target as being one of post-quantum computing safe and post-quantum computing unsafe based on the cipher suite dependency graph and based on a predetermined rule for each cipher suite in the collection of cipher suites.

### Example Embodiments

As will be explained below, a goal of the described embodiments is to analyze systems, Application Programming Interfaces (APIs), and/or software code to identify post-quantum risk posed thereby by, e.g., determining locations of, e.g., a post-quantum unsafe library, a post-quantum unsafe algorithm, or a post-quantum unsafe policy for cryptography, classifying how such a library, algorithm, or policy might impact data security, and determining how such post-quantum unsafe vulnerabilities can be remediated.

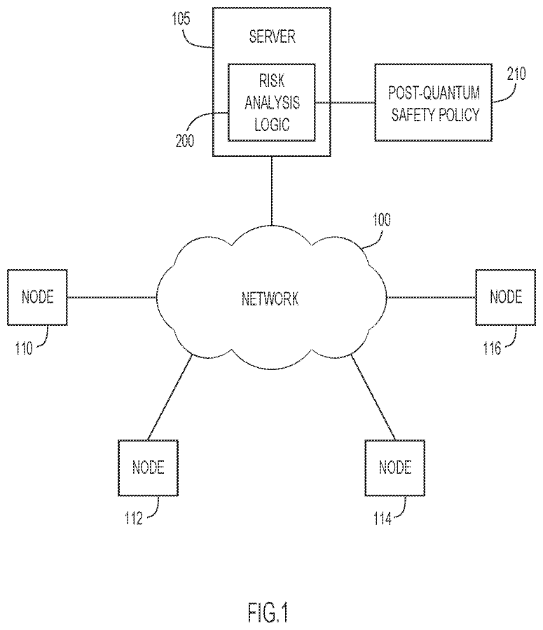

FIG. 1 shows several nodes, interconnected by an electronic network, including one node that hosts risk analysis logic 200, according to an example embodiment. Specifically, the figure shows node 110, node 112, node 114, node 116, and a server 105 interconnected via network 100. Network 100 may be a private network or public network such as the Internet. Server 105 hosts risk analysis logic 200. The function of risk analysis logic 200 is to scan any one or more of node 110, node 112, node 114, or node 116 and identify systems, Application Programming Interfaces (APIs), and/or software code to identify post-quantum risk that may be posed by any of those nodes and/or operations conducted thereby. Whether a particular system, API or, software code repository poses a post-quantum computing risk may be determined in conjunction with post-quantum safety policy 210, which may comprise a set of rules, examples of which are described below.

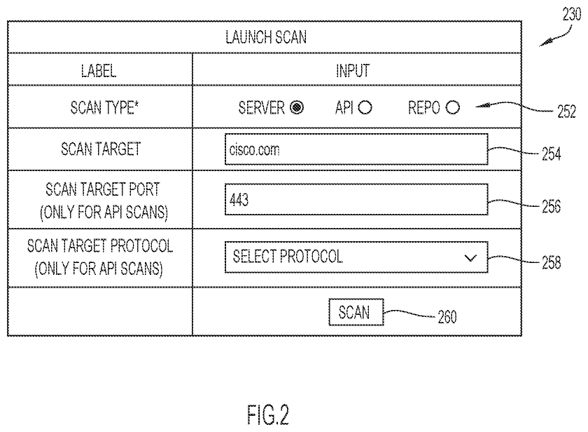

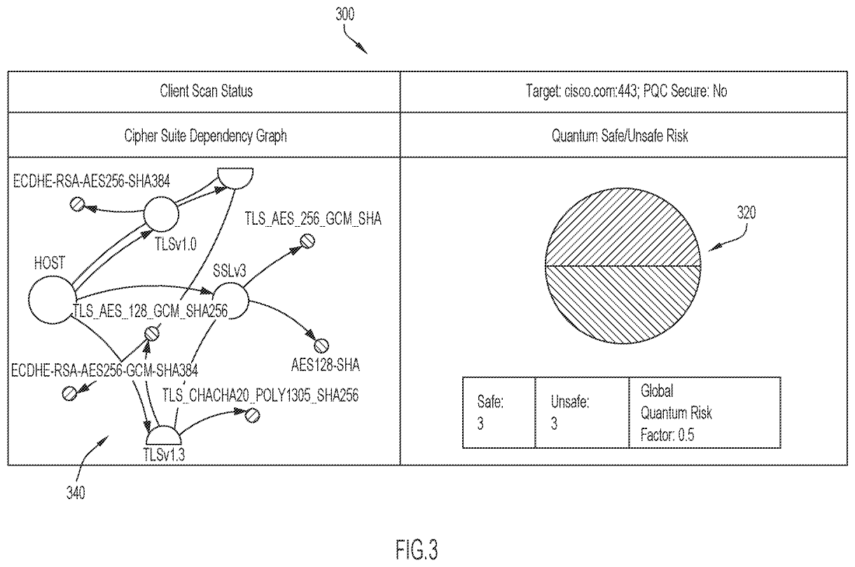

FIG. 2 shows an example input user interface 230 that is used to initiate a scan of a target using risk analysis logic 200, according to an example embodiment. A scan type is entered using, e.g., radio buttons in area 252. The target could be of a server, an API, or a code repository (repo) that is hosted and/or accessible via, e.g., node 110, node 112, node 114, or node 116. A name of the target, i.e., the scan target may be entered in area 254. In the case of an API being the target, a scan target port number may be entered in area 256, and, also in the case of an API being the target, a scan target protocol may be indicated in area 258. Once the several fields are completed, a user may initiate a scan by operating a scan button 260 that causes risk analysis logic 200 to scan the indicated target device, API, or code repository.

In an embodiment, risk analysis logic 200 is configured, based on a scan of the target, to identify unsafe cipher suites, libraries, or configurations for keys or cryptography with respect to post-quantum safety policy 210, identify the cryptographic call sequences or function call sequences that lead to an unsafe cryptographic call, i.e., cryptographic call paths that are not safe, identify insecure cryptographic implementations irrespective of quantum or classical computing, and generate a color-coded visualization of the risk analysis along with a risk score for quantum safety per entity such as a network endpoint, client, API, source code, etc. Remediation of unsafe cipher suites may also be performed.

FIG. 3 shows an example user interface 300 depicting a cipher suite dependency graph and a graphical indication of risk determination for the target generated by risk analysis logic 200, according to an example embodiment. On the left side of FIG. 3, a host (i.e., the target node) is shown along with arrows showing the cipher suites with which the host interacts, or via which target node host communication passes to reach another node, application, etc. That is, the left side of FIG. 3 shows a cipher suite dependency graph 320 that identifies the cipher suites being used at different nodes and/or for different operations associated with the target node. Cipher suites such as RSA, AES, SHA, along with secure socket layer (SSL) and transport layer security (TLS) may be employed in different forms and combinations by different nodes or application instances. Risk analysis logic 200 is configured to first identify the relevant cipher suites, generate the dependency graph 320, and then apply the post-quantum safety policy 210 to each cipher suite to assess its post quantum computing security risk.

The right side of FIG. 3 depicts a graphical pie chart 340 comparing detected safe and unsafe cipher suite risks in the dependency graph. In this specific example, risk analysis logic 200 has assessed that three detected cipher suites are safe (e.g., presented as a green color), and three detected cipher suites are assessed as unsafe (e.g., presented as a red color) such that pie chart 340 shows a 50/50 ratio, and a global quantum risk factor is noted at 0.5.

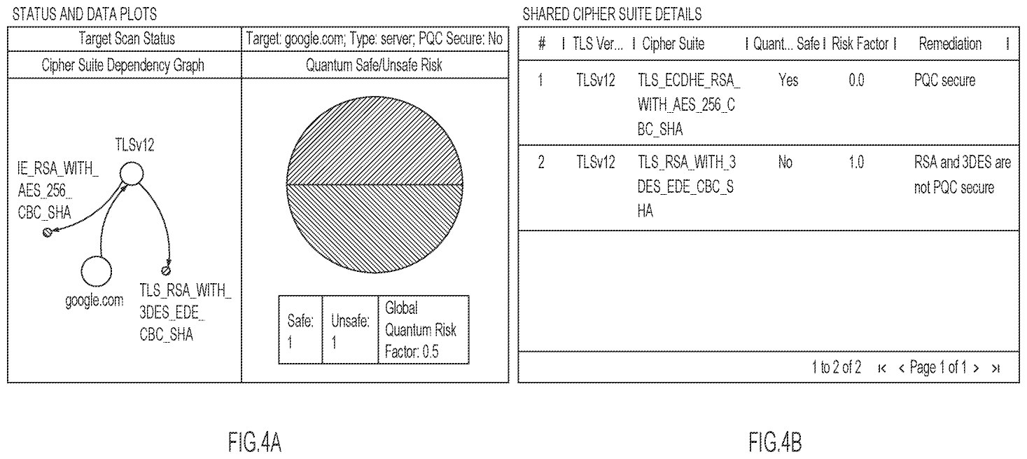

FIG. 4A shows an example user interface depicting a cipher suite dependency graph and FIG. 4B shows a corresponding listing of cipher suite details generated for a target by risk analysis logic 200, according to an example embodiment. That is, FIG. 4A is a simpler dependency graph compared to that shown in FIG. 3, and FIG. 4B lists in, a detail view, the two, in this example, cipher suites detected by risk analysis logic 200. The detail view may indicate TLS version, a name of the cipher suite, whether the cipher suite is considered post quantum computing safe, and a risk factor (which may be used to calculate the global quantum risk factor). FIG. 4B also depicts a remediation field for each entry. As can be seen in the figure, the first entry is deemed to be post-quantum computing safe (with a risk factor of 0.0), and the second entry is deemed to be not safe (with a risk factor of 1.0). The remediation field indicates that at least some parts or components of the that cipher suite, namely, in this case, RSA and triple Data Encryption Standard (3DES) are not PQC (post-quantum computing) secure or safe. Such cipher suites may then be remotely turned off (such that that functionality is disabled), updated manually, or updated automatically. Automatic update may be implemented through an automatic upgrade, an automatic remove and replace function, or a remote reconfiguration such that the PQC unsafe cipher suite is converted to a safe PQC cipher suite.

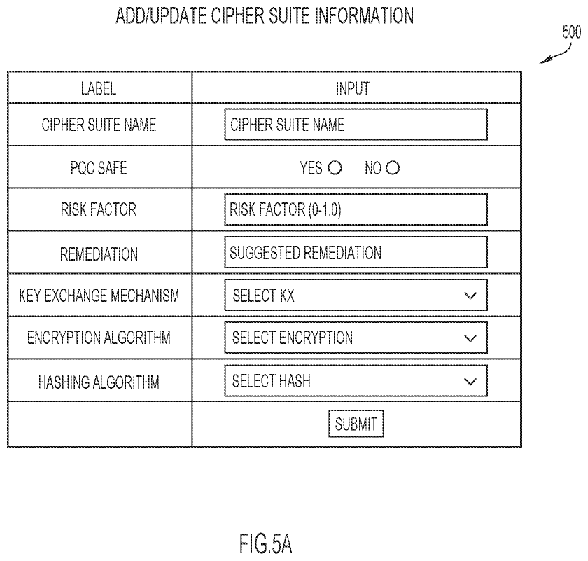

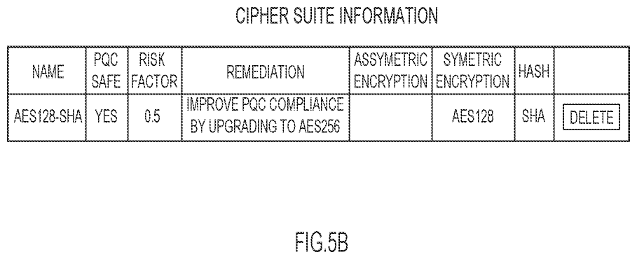

FIG. 5A shows an example user interface 500 for updating a database associated with, e.g., post-quantum safety policy 210, that stores information about individual cipher suites and that is employed by risk analysis logic 200 to perform risk analysis, according to an example embodiment. FIG. 5B illustrates a single entry of such a database. As shown, user interface 500 includes a field for a cipher suite name, a field for indicating whether that cipher suite is PQC safe or unsafe, a field for assigning a risk factor to that cipher suite, a field for providing a remediation action, a field for indicating a key exchange mechanism, a field for identifying an encryption algorithm used by the cipher suite, and a hashing algorithm used by the cipher suite. FIG. 5B shows a single entry of a database that may be built up via the use of the user interface 500 of FIG. 5A. As indicated by a delete button, any row may be deleted, as may be appropriate.

The following are examples of PQC unsafe cipher suites, and considerations for corresponding remediation actions for the PQC unsafe cipher suites.
RSA-based cipher suites
Elliptic curve cryptography-based cipher suites
AES 128-bit-based cipher suites

Where or how the PQC unsafe cryptography cipher suite is deployed may dictate a remediation technique. For example, if the deployment is based, or embedded, in hardware, then the hardware itself may be replaced. On the other hand, if the deployment is software- or code-based, then a manual or automatic code upgrade, may be possible.

A process by which scanning is performed is discussed next. For a network endpoint (e.g., a server) and an API, risk analysis logic 200 may analyze the network endpoint's connection and packets. For an API, risk analysis logic 200 may execute the API, and analyze its connection parameters. For a source code repository, risk analysis logic 200 may carry out static code analysis and/or dynamic code analysis.

From that analysis, risk analysis logic 200 determines the cipher suites being used by the target and builds a cipher suite dependency graph from the data collected and the information known about the protocol and network connections. In a given cipher suite dependency graph, each vertex may represent a specific algorithm, library, or cipher suite being used, and an edge may represent the caller-callee relationship, or dependency.

Risk analysis logic 200 can then further ascertain the cryptographic call sequences or function call sequences that lead to an unsafe cryptographic call, i.e., a path that a call traverses through cipher suites cryptographic paths that are not PQC safe.

Risk analysis logic 200 accesses a database built up within, or that is accessible to, post-quantum safety policy 210 to identify safe and unsafe post-quantum libraries, compliance-aware implementation of post-quantum algorithms, incorrect or unsafe or invalid implementations, and insecure cryptographic implementations irrespective of quantum or classical computing.

Risk analysis logic 200 may generate a (color-coded) cipher suite dependency graph that may be presented to a user via a display, as shown in, e.g., FIGS. 3 and 4A.

Risk analysis logic 200 may also compute a risk score for quantum safety per entity (for each network endpoint (server, client), API, and/or source code repository. The computed risk score may an aggregated risk score, which could be a weighted average, and/or be based, or presented, on a per hop basis as a call propagates through the cipher suite dependency graph.

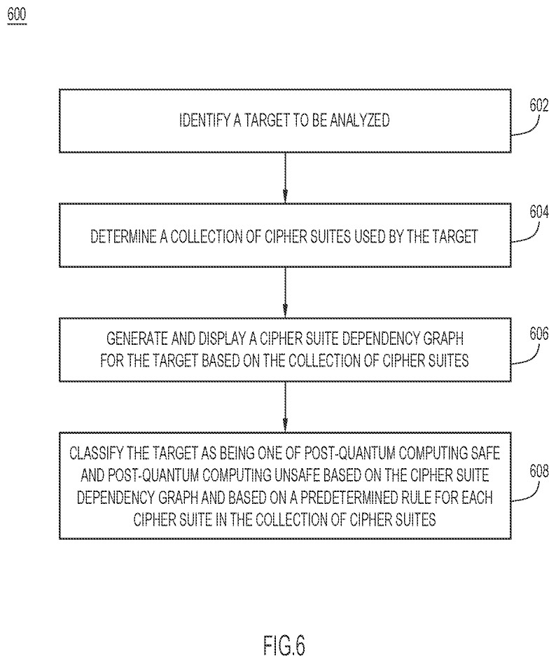

FIG. 6 is a flowchart 600 illustrating a series of example operations executed by risk analysis logic, according to an example embodiment. At 602, an operation includes identifying a target to be analyzed. At 604, an operation includes determining a collection of cipher suites used by the target. At 606, an operation includes generating and displaying a cipher suite dependency graph for the target based on the collection of cipher suites. And, at 608, an operation includes classifying the target as being one of post-quantum computing safe and post-quantum computing unsafe based on the cipher suite dependency graph and based on a predetermined rule for each cipher suite in the collection of cipher suites.

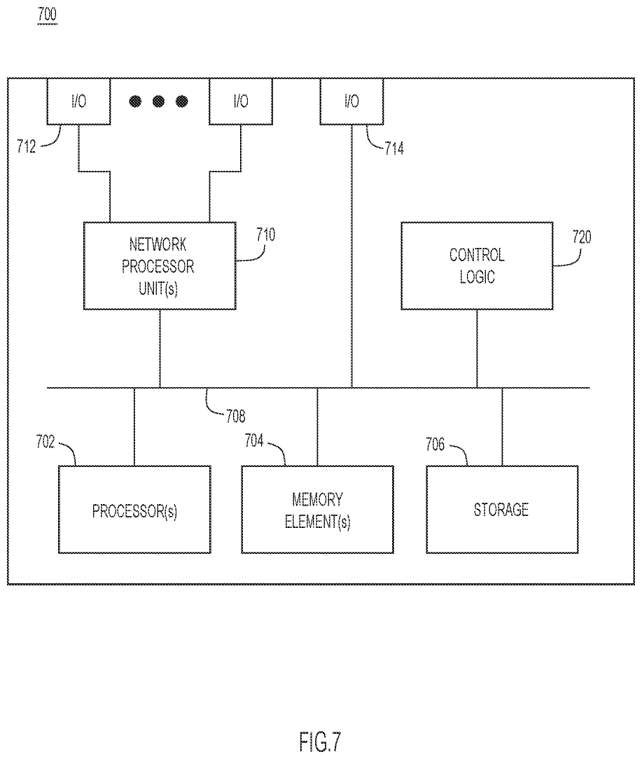

FIG. 7 is a block diagram of a computing device that may be configured to execute risk analysis logic 200 and perform the techniques described herein, according to an example embodiment. In various embodiments, a computing device, such as computing device 700 or any combination of computing devices 700, may be configured as any entity/entities as discussed for the techniques depicted in connection with FIGS. 1-6 in order to perform operations of the various techniques discussed herein.

In at least one embodiment, the computing device 700 may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720 (which could include, for example, risk analysis logic 200. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa) or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to computing device 700. For example, I/O interface(s) 714 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™ mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of and ‘one or more of’ can be represented using the ‘(s)’ nomenclature (e.g., one or more element(s)).

In sum, a computer-implemented method may include identifying a target to be analyzed, determining a collection of cipher suites used by the target, generating and displaying a cipher suite dependency graph for the target based on the collection of cipher suites, and classifying the target as being one of post-quantum computing safe and post-quantum computing unsafe based on the cipher suite dependency graph and based on a predetermined rule for each cipher suite in the collection of cipher suites.

In the method, the target may be at least one of an endpoint, an application programming interface, and source code.

In the method, a vertex in the cipher suite dependency graph may represent a specific cipher suite, and an edge in the cipher suite dependency graph represents a caller-callee relationship.

The method may further include generating a database of cipher suites and respective corresponding risk scores, and accessing the database when classifying the target as being post-quantum computing safe or unsafe.

The method may further include generating and displaying an aggregate risk score for the target based on the respective corresponding risk scores.

In the method, the aggregate risk score may be based on a weighted average of respective risk scores.

The method may further include generating and displaying a pie chart indicative of a ratio of safe to unsafe post-quantum computing cipher suites in the collection of cipher suites.

The method may further include identifying and displaying a remediation action to convert a post quantum computing unsafe target to a post quantum computing safe target.

The method may further include automatically initiating the remediation action.

In the method, the predetermined rule may include an indication of whether a given cipher suite in the collection of cipher suites is post-quantum computing safe or post-quantum computing unsafe.

In another embodiment, a device may be provided and may include an interface configured to enable network communications, a memory, and one or more processors coupled to the interface and the memory, and configured to: identify a target to be analyzed, determine a collection of cipher suites used by the target, generate and display a cipher suite dependency graph for the target based on the collection of cipher suites, and classify the target as being one of post-quantum computing safe and post-quantum computing unsafe based on the cipher suite dependency graph and based on a predetermined rule for each cipher suite in the collection of cipher suites.

In the device, the target may be at least one of an endpoint, an application programming interface, and source code.

In the device, a vertex in the cipher suite dependency graph may represent a specific cipher suite, and an edge in the cipher suite dependency graph represents a caller-callee relationship.

In the device, the one or more processors may be further configured to generate a database of cipher suites and respective corresponding risk scores, and access the database when classifying the target as being post-quantum computing safe or unsafe.

In the device, the one or more processors may be further configured to generate and display an aggregate risk score for the target based on the respective corresponding risk scores.

In the device, the aggregate risk score may be based on a weighted average of respective risk scores.

In the device, the one or more processors may be further configured to identify and display a remediation action to convert a post quantum computing unsafe target to a post quantum computing safe target and to automatically initiate the remediation action.

In yet another embodiment, one or more non-transitory computer readable storage media encoded with instructions are provided and that, when executed by a processor, cause the processor to: identify a target to be analyzed, determine a collection of cipher suites used by the target, generate and display a cipher suite dependency graph for the target based on the collection of cipher suites, and classify the target as being one of post-quantum computing safe and post-quantum computing unsafe based on the cipher suite dependency graph and based on a predetermined rule for each cipher suite in the collection of cipher suites.

The one or more non-transitory computer readable storage media, wherein the target may be at least one of an endpoint, an application programming interface, and source code.

The one or more non-transitory computer readable storage media, wherein a vertex in the cipher suite dependency graph may represent a specific cipher suite, and an edge in the cipher suite dependency graph represents a caller-callee relationship.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
identifying a target to be analyzed;
determining a collection of cipher suites used by the target;
generating and displaying a cipher suite dependency graph for the target based on the collection of cipher suites; and
classifying the target as being one of post-quantum computing safe and post-quantum computing unsafe based on the cipher suite dependency graph and based on a predetermined rule for each cipher suite in the collection of cipher suites.

2. The method of claim 1, wherein the target is at least one of an endpoint, an application programming interface, and source code.

3. The method of claim 1, wherein a vertex in the cipher suite dependency graph represents a specific cipher suite, and an edge in the cipher suite dependency graph represents a caller-callee relationship.

4. The method of claim 1, further comprising generating a database of cipher suites and respective corresponding risk scores, and accessing the database when classifying the target as being post-quantum computing safe or unsafe.

5. The method of claim 4, further comprising generating and displaying an aggregate risk score for the target based on the respective corresponding risk scores.

6. The method of claim 5, wherein the aggregate risk score is based on a weighted average of respective risk scores.

7. The method of claim 1, further comprising generating and displaying a pie chart indicative of a ratio of safe to unsafe post-quantum computing cipher suites in the collection of cipher suites.

8. The method of claim 1, further comprising identifying and displaying a remediation action to convert a post quantum computing unsafe target to a post quantum computing safe target.

9. The method of claim 8, further comprising automatically initiating the remediation action.

10. The method of claim 1, wherein the predetermined rule comprises an indication of whether a given cipher suite in the collection of cipher suites is post-quantum computing safe or post-quantum computing unsafe.

11. A device comprising:
an interface configured to enable network communications;
a memory; and
one or more processors coupled to the interface and the memory, and configured to:
identify a target to be analyzed;
determine a collection of cipher suites used by the target;
generate and display a cipher suite dependency graph for the target based on the collection of cipher suites; and
classify the target as being one of post-quantum computing safe and post-quantum computing unsafe based on the cipher suite dependency graph and based on a predetermined rule for each cipher suite in the collection of cipher suites.

12. The device of claim 11, wherein the target is at least one of an endpoint, an application programming interface, and source code.

13. The device of claim 11, wherein a vertex in the cipher suite dependency graph represents a specific cipher suite, and an edge in the cipher suite dependency graph represents a caller-callee relationship.

14. The device of claim 11, the one or more processors are further configured to generate a database of cipher suites and respective corresponding risk scores, and access the database when classifying the target as being post-quantum computing safe or unsafe.

15. The device of claim 14, the one or more processors are further configured to generate and display an aggregate risk score for the target based on the respective corresponding risk scores.

16. The device of claim 15, wherein the aggregate risk score is based on a weighted average of respective risk scores.

17. The device of claim 11, the one or more processors are further configured to identify and display a remediation action to convert a post quantum computing unsafe target to a post quantum computing safe target and to automatically initiate the remediation action.

18. One or more non-transitory computer readable storage media encoded with instructions that, when executed by a processor, cause the processor to:
identify a target to be analyzed;
determine a collection of cipher suites used by the target;
generate and display a cipher suite dependency graph for the target based on the collection of cipher suites; and
classify the target as being one of post-quantum computing safe and post-quantum computing unsafe based on the cipher suite dependency graph and based on a predetermined rule for each cipher suite in the collection of cipher suites.

19. The one or more non-transitory computer readable storage media of claim 18, wherein the target is at least one of an endpoint, an application programming interface, and source code.

20. The one or more non-transitory computer readable storage media of claim 18, wherein a vertex in the cipher suite dependency graph represents a specific cipher suite, and an edge in the cipher suite dependency graph represents a caller-callee relationship.
